(19) United States
(12) Patent Application Publication
(10) Pub. No.: US 2018/0365622 A1
(43) Pub. Date: Dec. 20, 2018

(54) SYSTEM AND METHOD FOR TRANSMITTING ALERTS

(71) Applicant: HCL TECHNOLOGIES LIMITED, Noida (IN)

(72) Inventors: Prathameshwar Pratap SINGH, Noida (IN); Arvind MAURYA, Noida (IN); Yogesh GUPTA, Noida (IN)

(21) Appl. No.: 16/005,504

(22) Filed: Jun. 11, 2018

(30) Foreign Application Priority Data
Jun. 16, 2017 (IN) 201711021183

(51) Int. Cl. G06Q 10/06; H04L 12/58; G06F 17/27; G06N 99/00

(52) U.S. Cl. CPC G06Q 10/063114; G06N 99/005; G06F 17/2785; H04L 51/16

(57) ABSTRACT

The present disclosure relates to system(s) and method(s) for logging tasks and and transmitting alerts to a user. The method may comprise receiving raw data, associated with a set of activities corresponding to a user. The raw data may be received from a set of data sources. The method may further comprise generating a conversation thread associated with a target activity from the set of activities. The method may further comprise identifying at least one abnormal event associated with the conversation thread, based on analysis of the conversation thread using one or more data analysis algorithms. The method may further comprise transmitting one or more alerts to a user or one or more other users associated with the conversation thread. The one or more alerts may be generated based on the abnormal event corresponding to the conversation thread.

### CROSS-REFERENCE TO RELATED APPLICATIONS AND PRIORITY

This present application claims benefit from Indian Complete Patent Application No 201711021183 filed on 16 Jun. 2017, the entirety of which is hereby incorporated by reference.

### TECHNICAL FIELD

The present disclosure in general relates to the field of task identification. More particularly, the present invention relates to a system and method for logging and tracking tasks based on analysis of user activities.

### BACKGROUND

Nowadays, users in the Information Technology era are indulged into lots of electronic conversations, documentations, chat and emails for business development and day to day activities. As the number of conversations go on increasing, a common problem of remembering the deadlines for send notifications, track work status and respond/reply timely on communications is faced by every user. Due to these situations, professional and personal level of complexity has increased. Managing business and jobs for timely delivery and risk assessment are getting failed. Currently, there is no such eco system build to tackle each such scenarios. Almost every activity is manually handled. Without a comprehensive and intelligent solutions, it is difficult to remember progress status, task's previous status, manage timely follow-ups and replies. Due to this an undesirable negative impact on running business, projects, and jobs to satisfy customers is observed. Some of the common problems in activity tracking are remembering upcoming events and meetings, manually tracking status, send follow-ups emails, and creating action items in applications or excel sheets for send them to the recipients.

These common problems in activity tracking make it very difficult to control and manage day to day life. The existing software tools/solutions available in the art are limited to the inputs shared by a user. These software tools/solutions fail when it comes to generation and tracking of day to day activities.

### SUMMARY

This summary is provided to introduce aspects related to a system and method for transmitting alerts to a user and the aspects are further described below in the detailed description. This summary is not intended to identify essential features of the claimed subject matter nor is it intended for use in determining or limiting the scope of the claimed subject matter.

In one embodiment, a method for logging tasks and transmitting alerts to a user is illustrated. The method may comprise receiving, by a processor, raw data, associated with a set of activities corresponding to a user. The raw data may be received from a set of data sources. The method may further comprise generating, by the processor, a conversation thread associated with a target activity from the set of activities. The conversation thread may be determined based on analysis of raw data using a Data Dictionary. The method may further comprise identifying, by the processor, at least one abnormal event associated with the conversation thread, based on analysis of the conversation thread using one or more data analysis algorithms. The method may further comprise transmitting, by the processor, one or more alerts to a user or one or more other users associated with the conversation thread. The one or more alerts may be generated based on the abnormal event corresponding to the conversation thread.

In another embodiment, a system for logging tasks and transmitting alerts to a user is illustrated. The system comprises a memory and a processor coupled to the memory, further the processor may be configured to execute programmed instructions stored in the memory. The processor may execute the programmed instructions stored in the memory for receiving raw data, associated with a set of activities corresponding to a user. The raw data may be received from a set of data sources. The processor may further execute the programmed instructions stored in the memory for generating a conversation thread associated with a target activity from the set of activities. The conversation thread may be determined based on analysis of raw data using a Data Dictionary. The processor may further execute the programmed instructions stored in the memory for identifying at least one abnormal event associated with the conversation thread, based on analysis of the conversation thread using one or more data analysis algorithms. The processor may further execute the programmed instructions stored in the memory for transmitting one or more alerts to a user or one or more other users associated with the conversation thread. The one or more alerts may be generated based on the abnormal event corresponding to the conversation thread.

In yet another embodiment, a computer program product having embodied computer program for logging tasks and transmitting alerts to a user is disclosed. The program may comprise a program code for receiving raw data, associated with a set of activities corresponding to a user. The raw data may be received from a set of data sources. The program may further comprise a program code for generating a conversation thread associated with a target activity from the set of activities. The conversation thread may be determined based on analysis of raw data using a Data Dictionary. The program may further comprise a program code for identifying at least one abnormal event associated with the conversation thread, based on analysis of the conversation thread using one or more data analysis algorithms. The program may further comprise a program code for transmitting one or more alerts to a user or one or more other users associated with the conversation thread. The one or more alerts may be generated based on the abnormal event corresponding to the conversation thread.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for logging tasks and transmitting alerts to a user, in accordance with an embodiment of the present subject matter.

FIG. 2 illustrates the system for logging tasks and transmitting alerts to a user, in accordance with an embodiment of the present subject matter.

FIG. 3 illustrates a method for logging tasks and transmitting alerts to a user, in accordance with an embodiment of the present subject matter.

### DETAILED DESCRIPTION

Some embodiments of the present disclosure, illustrating all its features, will now be discussed in detail. The words “receiving”, “generating”, “identifying”, “transmitting”, and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Various modifications to the embodiment will be readily apparent to those skilled in the art and the generic principles herein may be applied to other embodiments. However, one of ordinary skill in the art will readily recognize that the present disclosure for transmitting alerts is not intended to be limited to the embodiments illustrated, but is to be accorded the widest scope consistent with the principles and features described herein.

The present subject matter relates to a system and method for logging tasks and transmitting alerts based on analysis of user activity data received from a set of data sources. The system is configured to receiving raw data, associated with a set of activities corresponding to a user. The raw data may be received from a set of data sources. In one embodiment data mining algorithms and data science techniques may be used to quickly extract raw data. The raw data may comprise un-structured or structured data that can be used for building and training a reusable data model.

In one embodiment, raw data may correspond to individual customer, employee, project or an organization. This raw data may be analysed for risk assessment and status. Based on the current analysis and historical analysis data, an artificial intelligence may be developed to enable end users in day to day activities. Further, the system/Virtual Email Secretary is configured to analyse the raw data to identify at least one conversation thread associated with follow-up reminders, status updates, risks identifications and business development opportunities.

In one embodiment, the system enables scanning incoming and outgoing email contents and apply Natural Language Processing to understand and analyse the day to day conversations of a user with other users of systems. Based on conversations the system is configured to generate and log tasks, add follow-up reminders and monitor execution status. Furthermore, based on the tracking of tasks, the system may be configured to generate status report with indicating % completion of tasks at a given point of time. In one embodiment, the system may be implemented over a cloud hosted environment.

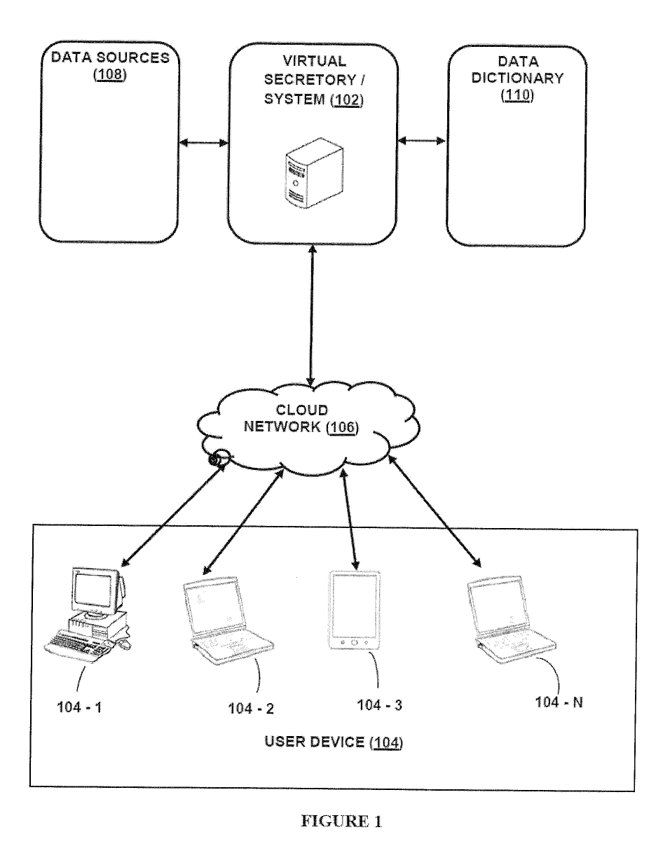

Referring now to FIG. 1, a network implementation 100 of a virtual secretory/system 102 for logging tasks and transmitting alerts based on analysis of user activity data is disclosed. Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented in a cloud-based environment. It will be understood that the system 102 may be accessed by multiple users through one or more user devices 104-1, 104-2 . . . 104-N, collectively referred to as user device 104 hereinafter, or applications residing on the user device 104. Examples of the user device 104 may include, but are not limited to, a portable computer, a personal digital assistant, a handheld device, and a workstation. The user device 104 may be communicatively coupled to the system 102 through a cloud network 106. Further, the system 102 may be communicatively coupled with one or more data sources 108. The one or more data sources may include email communication channel, chatting applications, code repository, and project management tools. The system may further be connected to a data dictionary 110. The data dictionary enables identification of a conversation thread from the raw data.

In one implementation, the network 106 may be a wireless network, a wired network or a combination thereof. The network 106 may be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

In one embodiment, the Intelligent Virtual Secretory/system 102 is configured to communicate with a set of data sources comprising email clients, planning application systems such as MPP, as well as document and code repositories. The data sources may also comprise email servers or application servers for scanning documents, conversation, emails for each and every incoming and outgoing email. Further the system is configured to enable a real time analytics engine/data analysis module to process the raw data to identify any conversation thread using a data dictionary. Further, the activity tracking module enabled by the system 102 is configured to create tasks for tracking the conversation thread. Furthermore, the system 102 is configured to generate reports based on the tracking of conversation thread and one or more activities performed by the user.

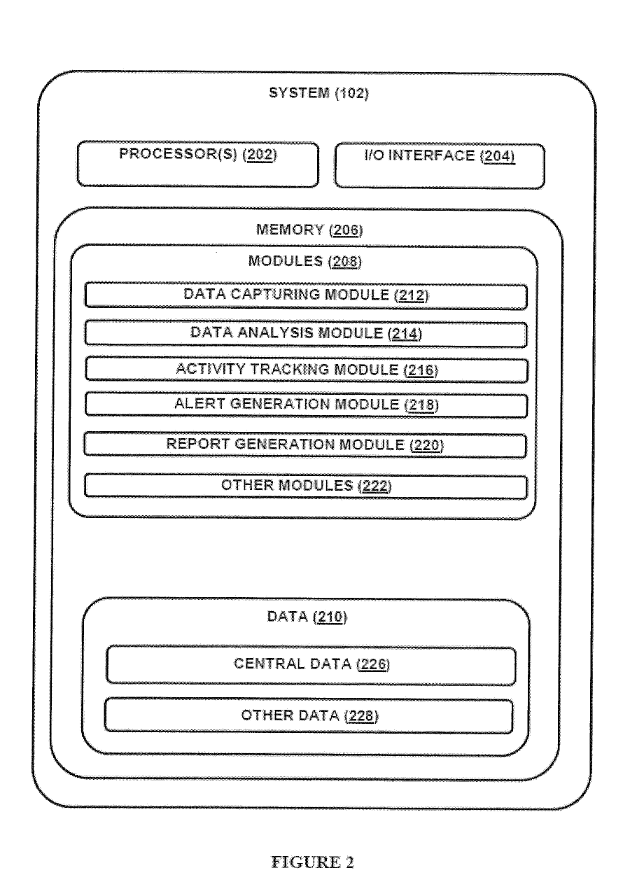

In one embodiment, the system 102 maintains the Data Dictionary 110 to validate content, attachments, documents and replies. The data analysis module is configured to use the data directory 110 in order to identify the conversation thread. Once the conversation thread is identified, the activity tracking module is configured to generate metadata corresponding to the conversation thread. This metadata is then used by the alert generation module to generate one or more tasks, alerts and/or reports. The alert generation module may further track the conversation thread in real-time and determine anomalies and abnormal activity. If any anomalies and abnormal activity is identified, the alert generation module may generate alerts and send these alerts to the user device 104. The system 102 for generating alerts based on analysis of user activity data is further elaborated with respect to the FIG. 2.

Referring now to FIG. 2, the system 102 for logging tasks and and transmitting alerts is illustrated in accordance with an embodiment of the present subject matter. In one embodiment, the system 102 may be configured to communicate with a set of data sources 108 and a data dictionary 110. The system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, at least one processor 202 may be configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the user device 104. Further, the I/O interface 204 may enable the system 102 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 may include routines, programs, objects, components, data structures, and the like, which perform particular tasks, functions or implement particular abstract data types. In one implementation, the module 208 may include a data capturing module 212, a data analysis module 214, an activity tracking module 216, an alert generation module 218, a report generation module 220, and other modules 222. The other modules 222 may include programs or coded instructions that supplement applications and functions of the system 102.

The data 210, amongst other things, serve as a repository for storing data processed, received, and generated by one or more of the modules 208. The data 210 may also include a central data 226, and other data 228. In one embodiment, the other data 228 may include data generated as a result of the execution of one or more modules in the other module 222.

In one implementation, a user may access the system 102 via the I/O interface 204. The user may be registered using the I/O interface 204 in order to use the system 102. In one aspect, the user may access the I/O interface 204 of the system 102 for obtaining information, providing inputs or configuring the system 102.

In one embodiment, the data capturing module 212 may be configured to receive raw data, associated with a set of activities corresponding to a user. The raw data may be received from the set of data sources 108. In one embodiment, data sources 108 may comprise one or more of an email communication channel, a chatting application, a code repository, and a project management tool. The user may be registered with the set of data sources with the system 102. In one embodiment the set of activities may comprise at least one of email communication activity, chatting activity, a mobile communication activity, project management activity, and the like.

Once the raw data is received, the data analysis module 214 is configured to generate a conversation thread associated with a target activity from the set of activities. The conversation thread may be determined based on analysis of raw data using a Data Dictionary. The Data Dictionary may be configured to maintain a set of predefined keywords in order to perform natural language processing over the raw data. For example, the target activity may be email communication activity. The emails from the email communication activity may be analysed using the Data Dictionary to identify the conversation thread/task. The conversation thread may correspond to communication emails between a sales person and a business lead. All the email communication between the sales person and the business lead may be clubbed to generate the conversation thread.

Furthermore, the activity tracking module 216 is configured to identify at least one abnormal event associated with the conversation thread, based on analysis of the conversation thread using one or more data analysis algorithms. In one embodiment, the data analysis algorithms may be based on natural language processing and machine learning. The natural language processing may be enabled using Topic Modelling, LSA (Latent Semantic Analysis/Indexing) or LDA (Latent Dirichlet Allocation). In one example, the abnormal event may correspond to non-reply by the sales person to a business leads email.

Based on the abnormal event, the alert generation module 218 may transmit one or more alerts to a user or one or more other users associated with the conversation thread. The one or more alerts may be generated based on the abnormal event corresponding to the conversation thread. The alert may be in the form of a notification or a message instruction the user to respond to the abnormal activity.

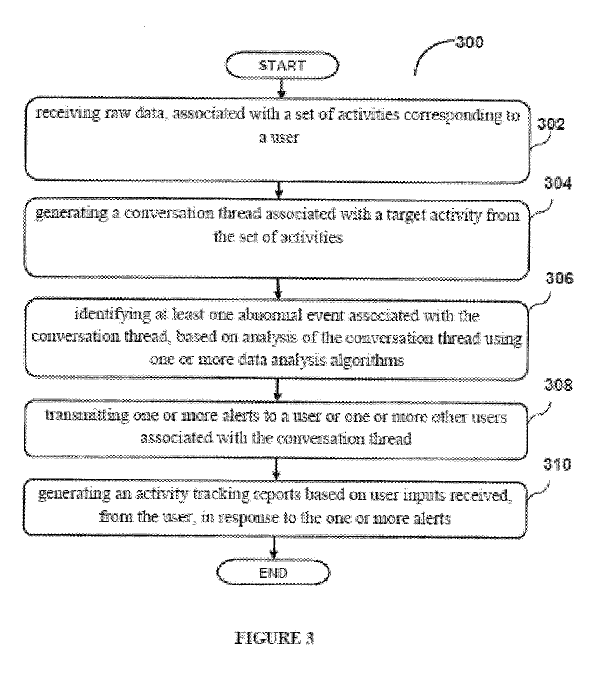

Furthermore, the report generation module 220 may be configured to capture user inputs received from the user in response to the one or more alerts. Furthermore, based on the user inputs received from the user, the report generation module 220 may generate an activity tracking reports based on user inputs received, from the user, in response to the one or more alerts. Further, the method for logging tasks and transmitting alerts to a user is elaborated with respect to the block diagram of FIG. 3.

Referring now to FIG. 3, a method 300 for logging tasks and transmitting alerts to a user, is disclosed in accordance with an embodiment of the present subject matter. The method 300 may be described in the general context of computer executable instructions. Generally, computer executable instructions can include routines, programs, objects, components, data structures, procedures, modules, functions, and the like, that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method 300 can be implemented in any suitable hardware, software, firmware, or combination thereof. However, for ease of explanation, in the embodiments described below, the method 300 may be considered to be implemented in the above described system 102.

At block 302, the data capturing module 212 may be configured to receive raw data, associated with a set of activities corresponding to a user. The raw data may be received from the set of data sources 108. In one embodiment, data sources 108 may comprise one or more of an email communication channel, a chatting application, a code repository, and a project management tool. The user may be registered with the set of data sources with the system 102. In one embodiment the set of activities may comprise at least one of email communication activity, chatting activity, a mobile communication activity, project management activity, and the like.

At block 304, once the raw data is received, the data analysis module 214 is configured to generate a conversation thread associated with a target activity from the set of activities. The conversation thread may be determined based on analysis of raw data using a Data Dictionary. The Data Dictionary may be configured to maintain a set of predefined keywords in order to perform natural language processing over the raw data to extract contextual information from the raw data. For example, the target activity may be email communication activity. The emails from the email communication activity may be analysed using the Data Dictionary to identify the conversation thread/task. The conversation thread may correspond to communication emails between a sales person and a business lead. All the email communication between the sales person and the business lead may be clubbed to generate the conversation thread.

At block 306, the activity tracking module 216 is configured to identify at least one abnormal event associated with the conversation thread, based on analysis of the conversation thread using one or more data analysis algorithms. In one embodiment, the data analysis algorithms may be based on natural language processing and machine learning. The natural language processing may be enabled using Topic Modelling, LSA (Latent Semantic Analysis/Indexing) or LDA (Latent Dirichlet Allocation) technique. In one example, the abnormal event may correspond to non-reply by the sales person to a business leads email.

At block 308, based on the abnormal event, the alert generation module 218 may transmit one or more alerts to a user or one or more other users associated with the conversation thread. The one or more alerts may be generated based on the abnormal event corresponding to the conversation thread. The alert may be in the form of a notification or a message instruction the user to respond to the abnormal activity.

At block 310, the report generation module 220 may be configured to capture user inputs received from the user in response to the one or more alerts. Furthermore, based on the user inputs received from the user, the report generation module 220 may generate an activity tracking reports based on user inputs received, from the user, in response to the one or more alerts.

Although implementations for systems and methods for logging tasks to a user and transmitting alerts to the user have been described, it is to be understood that the appended claims are not necessarily limited to the specific features or methods described. Rather, the specific features and methods are disclosed as examples of implementations for logging tasks and transmitting alerts to the user.

We claim:

1. A system for logging tasks and transmitting alerts, the system comprising:
a memory; and
a processor coupled to the memory, wherein the processor is configured to execute program instructions stored in the memory for:
receiving raw data, associated with a set of activities corresponding to a user, wherein the raw data is received from a set of data sources;
generating a conversation thread associated with a target activity from the set of activities, wherein the conversation thread is determined based on analysis of raw data using a Data Dictionary;
identifying at least one abnormal event associated with the conversation thread, based on analysis of the conversation thread using one or more data analysis algorithms; and
transmitting one or more alerts to a user or one or more other users associated with the conversation thread, wherein the one or more alerts are generated based on the abnormal event corresponding to the conversation thread.

2. The system of claim 1, wherein the data sources comprise one or more of email communication channel, chatting applications, code repository, and project management tools, and wherein the set of activities comprise at least one of email communication, chat history, mobile communication, and Project management tools.

3. The system of claim 1, wherein the data analysis algorithms are based on natural language processing and machine learning, wherein the natural language processing is enabled using Topic Modelling, LSA or LDA.

4. The system of claim 1, further configured for capturing user inputs received from the user in response to the one or more alerts.

5. The system of claim 1, further configured for generating an activity tracking reports based on user inputs received, from the user, in response to the one or more alerts.

6. A method for logging tasks and transmitting alerts, the method comprising steps of:
receiving, by a processor, raw data, associated with a set of activities, corresponding to a user, wherein the raw data is received from a set of data sources;
generating, by the processor, a conversation thread associated with a target activity from the set of activities, wherein the conversation thread is determined based on analysis of raw data using a Data Dictionary;
identifying, by the processor, at least one abnormal event associated with the conversation thread, based on analysis of the conversation thread using one or more data analysis algorithms; and
transmitting, by the processor, one or more alerts to a user or one or more other users associated with the conversation thread, wherein the one or more alerts are generated based on the abnormal event corresponding to the conversation thread.

7. The method of claim 6, wherein the data sources comprise one or more of email communication channel, chatting applications, code repository, and project management tools, and wherein the set of activities comprise at least one of email communication, chat history, mobile communication, and Project management tools.

8. The method of claim 6, wherein the data analysis algorithms are based on natural language processing and machine learning, wherein the natural language processing is enabled using Topic Modelling, LSA or LDA.

9. The method of claim 6, further configured for capturing user inputs received from the user in response to the one or more alerts.

10. The method of claim 6, further configured for generating an activity tracking reports based on user inputs received, from the user, in response to the one or more alerts.

11. A computer program product having embodied computer program for logging tasks and transmitting alerts to a user, the computer program product comprises:
a program code for receiving raw data, associated with a set of activities corresponding to a user, wherein the raw data is received from a set of data sources;
a program code for generating a conversation thread associated with a target activity from the set of activities, wherein the conversation thread is determined based on analysis of raw data using a Data Dictionary;
a program code for identifying at least one abnormal event associated with the conversation thread, based on analysis of the conversation thread using one or more data analysis algorithms; and
a program code for transmitting one or more alerts to a user or one or more other users associated with the conversation thread, wherein the one or more alerts are generated based on the abnormal event corresponding to the conversation thread.
